(19) United States
(12) Patent Application Publication
(10) Pub. No.: US 2008/0224986 A1
(43) Pub. Date: Sep. 18, 2008

(54) COLOR SEQUENTIAL DISPLAY HAVING BACKLIGHT TIMING DELAY CONTROL UNIT AND METHOD THEREOF

(75) Inventors: Hsueh-ying Huang, Hsin-Chu City (TW); Min-feng Chiang, Hsin-Chu City (TW); Yu-hui Chou, Hsin-Chu City (TW); Mei-sheng Ma, Hsin-Chu City (TW)

Correspondence Address: KIRTON AND MCCONKIE, 60 EAST SOUTH TEMPLE,, SUITE 1800, SALT LAKE CITY, UT, 84111, US

(73) Assignee: AU OPTRONICS CORP., Hsin-Chu City (TW)

(21) Appl. No.: 12/043,400

(22) Filed: Mar. 6, 2008

(30) Foreign Application Priority Data
Mar. 13, 2007 (TW) 096108601

(51) Int. Cl. G09G 3/36

(52) U.S. Cl. 345/102

(57) ABSTRACT

A color sequential display having backlight timing delay control unit and method thereof are described. The color sequential display includes a liquid crystal panel, a backlight source, a driving circuit, and a backlight delay control unit. The driving circuit generates a pixel voltage to drive the liquid crystal panel. The backlight delay control unit controls to delay the time of the turn-off status of the backlight source and thus adjusts the time of the turn-off between an end point of the second time interval of the at least one first sub-frame and an end point of the first time interval of the at least one second sub-frame.

### FIELD OF THE INVENTION

The present invention relates to a liquid crystal display, more particularly to a color sequential display having backlight timing delay control unit and method thereof.

### BACKGROUND OF THE INVENTION

The additive color hybrid process that is usually used in the liquid crystal displays may be roughly classified into two categories. One category is a space additive color hybrid process, such as a color filter technique. In the color filter technique, every pixel contains many sub-pixels with three primary colors, red, green and blue colors, also called RGB color, and thus the hybrid color is mainly produced in space, which is termed as the space additive color hybrid process. When the RGB sub-pixels are too small to be distinguished by human eyes, the colors are hybridized by controlling the luminance intensity passing through the RGB sub-pixels to achieve the color hybrid additive effect. For example, the conventional liquid crystal panel in FIG. 1a utilizes the color filter technique to form the frame 120. Since there are three color filter films (102a, 103a, and 104a) with the primary colors positioned on the color filter which is illuminated by a backlight source, the desired red light 110a, green light 111a, and blue light 112a are generated to hybridize each other by controlling the luminance intensity passing through the RGB sub-pixels.

The other category is the time sequential color hybrid process, such as the color sequential technique, which mainly hybridizes colors on the timing axes. The color sequential technique is usually used in the color sequential display, also called the field sequential display or the color filter-less display. The principle of the sequential color hybrid process is that the RGB light source is quickly and sequentially switched to form a color image or frame within the human visual staying time. That is, the chromas of the primary colors are shown on three different display intervals or sub-frames, but on the same pixel. If the switching operation of the RGB light source is too quick to be distinguished by the human eyes, human eyes cannot see the RGB respectively but see a hybrid color only. For example, a display with the display frequency, i.e. 60 Hz, needs to switch the three primary colors within (1/180) ms in order to sequentially display the three primary colors during the three display intervals or sub-frames, respectively. Due to the human visual staying phenomenon, three primary colors having different brightness intensity, respectively, are hybridized together to display the chromatic image.

FIG. 1b shows a liquid crystal display panel 10b which adopts the color sequential technique to form a frame 120. The time interval that the RGB backlight source generates a frame 120 is further divided into three display intervals, such as first sub-frame 121, second sub-frame 122 and third sub-frame 123, corresponding to the different color light sources. Thus, red color light source 107b, green color light source 108b, and blue color light source 109b are sequentially emitted, respectively, and are quickly shown on each pixel. Then, according to the response time of the liquid crystal 100b, the display result of the pixels are determined to generate the image with the additive hybrid colors, as shown in numbers 110b, 111b, and 112b.

Furthermore, in comparison with conventional color filter technique, the color sequential technique has many advantages such as:

(1) Displays adopting color sequential technique have high resolution due to no color resisters for increasing the space resolution of the panel pixels. Further, due to no light consumption resulting from the color resisters, the color sequential technique increases the transmittance of the panel pixels, and the transmittance of the color sequential display are increased from 27% to almost 100%.

(2) The manufacturing cost of color sequential display is effectively lowered. Color sequential display has no color filters, so the structure can be simplified, and the coating and treating procedures of the color filters can be omitted. In addition, the working-hour can be reduced and the yield can be increased.

(3) The number of driving integrated circuits of the color sequential display can be reduced. The driving integrated circuits output voltage to make the liquid crystal molecule orientations changed so as to control the transmittance of each pixel to form the display image. Moreover, the color sequential technique can decrease the number of thin film transistors in a single pixel so that the complexity of the control circuit can be simplified and the space resolution of the panel pixel can be improved.

(4) The color equilibrium can be adjusted better. Each independent light source can be adjusted to achieve a better uniformity of color displaying of the panel adopting an independent light source.

However, it should be noted that the display frequency of the conventional twisted nematic liquid crystal panel is 60 Hz. Further, the driving voltage of the conventional liquid crystal panel changes one time every 16.67 ms, so the liquid crystal can reach its standard value before the signal level change of the driving voltage is completed. Comparatively, the liquid crystal driving voltage of the color sequential liquid crystal display changes one time every 5.56 ms. In other words, the display interval of each sub-frame is 5.56 ms, and however, the turn-on time of the backlight source is one portion of the display interval 5.56 ms. Therefore, the response time of the liquid crystal becomes short because the liquid crystal molecules should complete the transition before the backlight source turns on.

Currently, the response time limitation of the liquid crystal is the main problem of the color sequential technique. Comparing with the conventional display using the color filter technique, it is necessary to take three times the response time of the conventional display to achieve the quality of the conventional display. That is, the response time of the color sequential display theoretically need to be decreased down to ⅓ the response time of the conventional display. If the response time of the color sequential display is not short enough, the following problems need to be considered:

(1) The Gamma curves drift on the gray-level. The Gamma curve shows the relationship between gray-level and brightness, which affect the color gradient of the liquid crystal display. If the response time of the liquid crystal changes according to the various gray levels, the Gamma curve drifts on the gray-level.

(2) The brightness on the display panel is not uniform. As shown in FIG. 2, it is a diagram of the scan time difference between the scan lines of the liquid crystal display panel. The display panel has a top pixel region 202, an intermediate pixel region 203, and a bottom pixel region 204. A gate driver 200 transversely scans the scan lines in a sequential manner of line by line from the top pixel region 202 to the bottom pixel region 204. Even if the driving frequency, i.e. 180 Hz, is adjusted to the response time of the liquid crystal, however, the scan time difference between the top pixel region 202 to the bottom pixel region 204 results in the uneven brightness on the display panel. The reason is that the liquid crystal in the bottom pixel region 204 does not totally make responses while the liquid crystal in the top pixel region 202 completes the response.

FIG. 3 is a coordinate diagram of the scan time difference between the scan lines of the liquid crystal display panel shown in FIG. 2. The horizontal coordinate represents the timing axis and the vertical coordinate represents the transmittance percentage. The display time 307 of each sub-frame includes the scan time 301 of the scan driving circuit, the waiting time 302 of the response of the liquid crystal and the starting time 303 of the backlight source. During the scan time 301, there is the scan time difference between the first scan line G001 at the scan time point T1 and the 160th scan line G160 at the scan time point T2. Passing the waiting time 302 to wait for the liquid crystal responding gradually, i.e. the rising profile, and then reaching the starting time 303 of the backlight source, the liquid crystal in the bottom pixel region 204 does not totally make responses because 160th scan line G160 is late to be scanned. Therefore, a transmittance difference region A3 is generated so that the transmittance between the top pixel region 202 and the bottom pixel region 204 is not uniform. That is, the transmittance corresponding to the first scan line G001 is greater than the transmittance corresponding to the 160th scan line G160.

FIG. 4 is a coordinate diagram of the relationship between the liquid crystal response time and the transmittance of the scan lines of the liquid crystal display in the prior art, which is called the black data insertion technology (BDI). After the liquid crystal display is past the time of the black data insertion 400 (or termed as RESET time), the brightness between the top pixel region 202 and the bottom pixel region 204 on the display panel is not uniform because the scan time difference between the scan lines and the response time of the liquid crystal is not short enough. In other words, while the response of the liquid crystal in the top pixel region 202, e.g. the first scan line G001, is complete but the liquid crystal in the bottom pixel region 204, e.g. the 160th scan line G160, does not totally make responses, the black data insertion 400 is performed and the backlight source is turned off. Furthermore, during the procedure of the black data insertion 400, it is necessary to correspond to the scan of the next sub-frame for the liquid crystal. Thus, after the procedure of the black data insertion 400 is complete, the scan of the next sub-frame for the liquid crystal is affected and the response time of the liquid crystal is further delayed. For this reason, the light transmittance between the top pixel region 202 and the bottom pixel region 204 is not consistent and the brightness is not uniform therebetween.

FIG. 5 is a coordinate diagram of the relationship between the liquid crystal response time and the transmittance of the liquid crystal display adopting the simultaneous black data insertion technique in the prior art. During the display time 507 of a sub-frame, the scanning driving sequentially starts to scan from the scan lines G001 to G160 within the scanning time 502. Further, the liquid crystal completely makes response past the waiting time 502 and the backlight source turns on in the starting time 503. Then, the scan driving circuit inputs a black data insertion signal to the scanning lines, respectively, during the time of black data insertion 500. FIG. 6 is a coordinate diagram of the relationship between the liquid crystal response time and the transmittance of the liquid crystal display adopting the sequential black data insertion technique in the prior art. The difference between FIG. 6 and FIG. 5 is that a black data insertion signal is sequentially inputted to the scanning lines, respectively, while performing the black data insertion technique. If the response time of the liquid crystal in FIG. 5 and FIG. 6 is not fast enough, the brightness uniformity issue on the top pixel region 202 and the bottom pixel region 204 is the same as the result in FIG. 4.

### SUMMARY OF THE INVENTION

In order to solve the above-mentioned problems, the present invention provides a color sequential display having backlight timing delay control unit to improve the brightness uniformity on the panel. The backlight delay control unit adjusts the time of the turn-off status of the backlight source to improve the uneven brightness between the top pixel region and the bottom pixel region due to time difference of the scan lines of the panel. For example, the backlight source is switched to the time of the turn-off status while or after the data of the next sub-frame is addressed.

The present invention provides a color sequential display having backlight timing delay control unit. The color sequential display includes a liquid crystal panel, a backlight source, a source data driving circuit, a gate scan driving circuit, a backlight control circuit, and a backlight delay control unit.

The liquid crystal panel has a plurality of pixels for generating a plurality of frames, wherein each frame is divided into a plurality of sub-frames having at least one first sub-frame and at least one second sub-frame. The backlight source generates light and provides the light to the liquid crystal panel. The driving circuit is electrically connected to at least one scan line and at least one data line for generating a first voltage and a second voltage to switch the turn-on/off statuses of the pixels and dividing each sub-frame into a first time interval and a second time interval. The first voltage switches the turn-on/off statuses of the pixels at the first time interval and the second voltage switches the turn-on/off statuses of the pixels at the second time interval. In one embodiment, the driving circuit includes a source data driving circuit and a gate scan driving circuit. The source data driving circuit generates a data line voltage, and the gate scan driving circuit sequentially provides a scanning line voltage.

The backlight control circuit provides a backlight driving voltage for driving the backlight source so that the backlight control circuit is capable of controlling the time of the turn-on status of the backlight source. For example, the backlight control circuit controls a plurality of light sources of the backlight source to correspondingly switch the light sources, which have a plurality of different colors, to the sub-frames.

The backlight delay control unit provides a delay control signal to adjust the time of turn-off status of the backlight source. In the color sequential display having backlight timing delay control unit of the present invention, the source data driving circuit and the gate scan driving circuit, respectively, are coupled to the pixel electrode. The pixel electrode is composed of a plurality of thin film transistors and each thin film transistor serves as a switch. That is, the backlight delay control unit for controlling the turn-off status of the backlight source and adjusting the time of the turnoff status between an end point of the second time interval of the at least one first sub-frame and an end point of the first time interval of the at least one second sub-frame.

When the source data driving circuit and gate scan driving circuit output a scan line voltage (or termed as a gate signal) and a data line voltage to the pixel electrode of the thin film transistor, respectively, via the scan line and the data line, the scan line voltage thus controls the on/off of the thin film transistor. The data line voltage is then inputted to the liquid crystal capacitance to control the twisting of liquid crystal molecules. When the thin film transistor is switched to the “off” status, high-impedance is generated to avoid the degradation of the data line voltage. However, the liquid crystal capacitance cannot retain the data line voltage until the next data line voltage is refreshed. Therefore, the liquid crystal capacitance is connected to the storage capacitance in parallel to retain the data line voltage until the next data line voltage is refreshed. The source data driving circuit and gate scan driving circuit generates a pixel voltage to drive the liquid crystal panel. The pixel voltage includes a first voltage and a second voltage to switch the turn-on/off statuses of the pixels. The first voltage switches the turn-on/off statuses of the pixels at the first time interval and the second voltage switches the turn-on/off statuses of the pixels at the second time interval. The backlight control circuit sequentially drives the RGB light source for outputting the image within the frame corresponding to an image. The backlight delay control unit outputs a delay signal to the backlight control circuit for adjusting the time of the turn-off status of the backlight source between an end point of the second time interval of the at least one first sub-frame and an end point of the first time interval of the at least one second sub-frame. As a result, the uneven brightness of the panel due to the scan time difference and liquid crystal response time is improved.

In operation, a method of controlling a color sequential display, using for delaying the backlight time of a backlight source of the color sequential display, is described. At least one frame of the color sequential display comprises at least one first sub-frame and at least one second sub-frame, and each sub-frame is divided into a first time interval and a second time interval. The method comprises the steps below. Firstly, at the time of the turn-on status of the at least one first sub-frame, the backlight source is turned on. Afterwards, the time of the turn-off status of the backlight source between an end point of the second time interval of the at least one first sub-frame and an end point of the first time Interval of the at least one second sub-frame is determined based on a predetermined time interval. Then, a backlight driving signal is delayed and the delayed backlight driving signal is outputted to the backlight source based on the time of the turn-off status of the backlight source.

Further, the predetermined time interval is added to the starting time point of the first time interval in each sub-frame to determine the time of the turn-off status of the backlight source, wherein the predetermined time interval is greater than the display interval in each sub-frame. In addition, the predetermined time interval is added also to the end time of the second time interval in each sub-frame to determine the time of the turn-off status of the backlight source, and the predetermined time interval is smaller than the first time interval in each sub-frame.

In one embodiment, the predetermined time interval is a default time interval of the turn-on status of the backlight source. A backlight delay control unit controls a backlight control circuit to delay the backlight driving signal and output the backlight driving signal to the backlight source based on the predetermined time interval. The backlight delay control unit is a hardware circuit or a software program.

Consequently, the time of the turn-off status of the backlight source is delayed to the next sub-frame so that backlight source has longer turn-on time to compensate the uneven brightness of the panel while the liquid crystal has no response time enough.

### BRIEF DESCRIPTION OF THE DRAWINGS

FIG. 1a and FIG. 1b are the diagrams of the conventional color filter and color sequential display techniques, respectively;

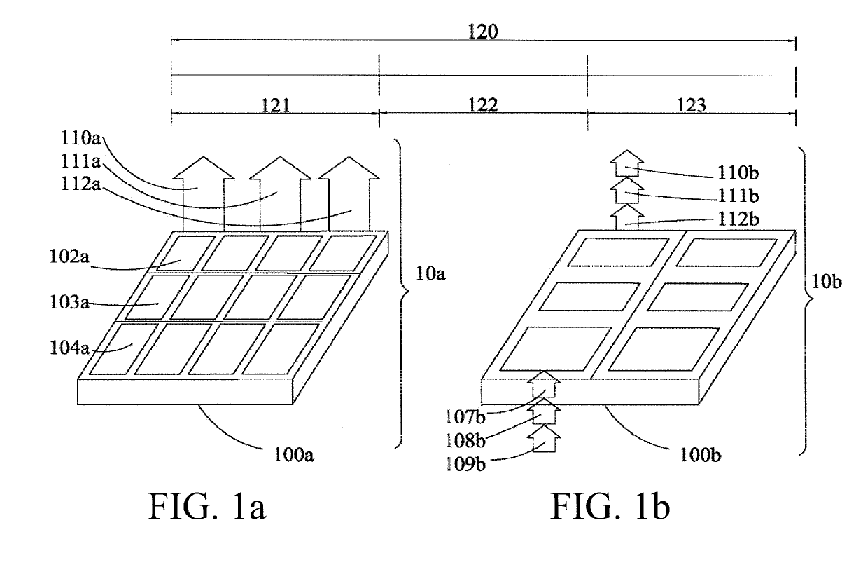

FIG. 2 is a diagram of the scan time difference between the scan lines of the liquid crystal display panel in the prior art;

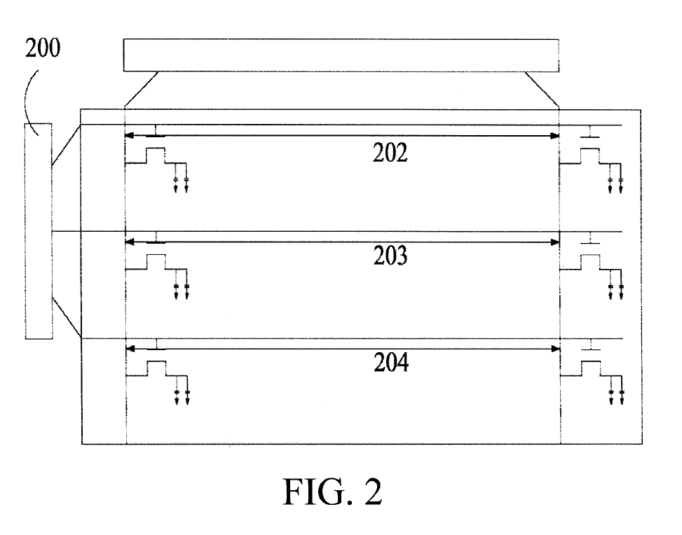

FIG. 3 is a coordinate diagram of the scan time difference between the scan lines of the liquid crystal display panel shown in FIG. 2;

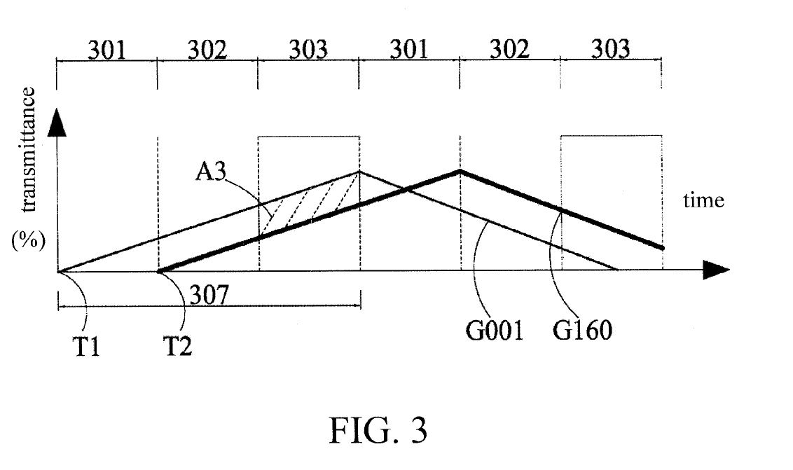

FIG. 4 is a coordinate diagram of the relationship between the liquid crystal response time and the transmittance of each scan line of the liquid crystal display in the prior art;

FIG. 5 is a coordinate diagram of the relationship between the liquid crystal response time and the transmittance of the liquid crystal display adopting the simultaneous black data insertion technique in the prior art;

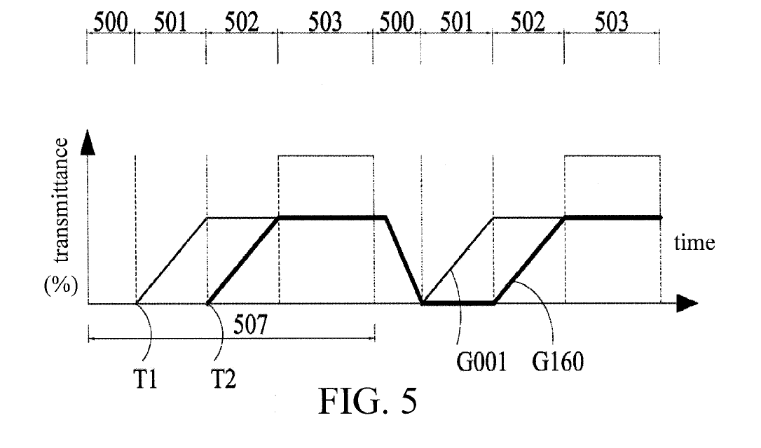

FIG. 6 is a coordinate diagram of the relationship between the liquid crystal response time and the transmittance of the liquid crystal display adopting the sequential black data insertion technique in the prior art;

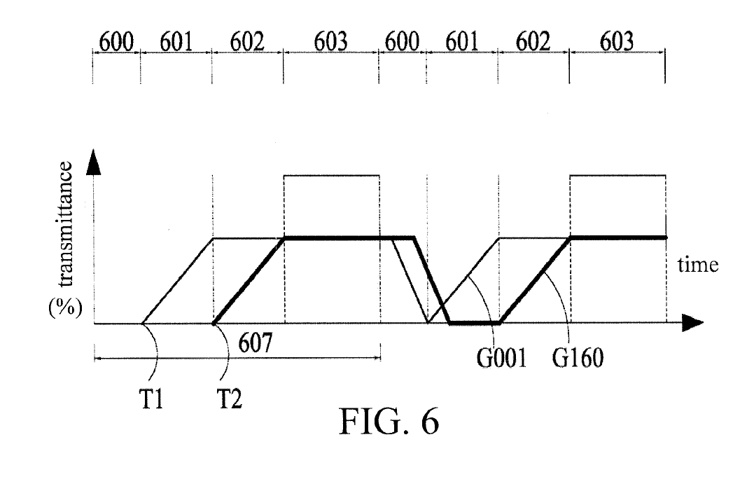

FIG. 7 is a block diagram of a color sequential display according to the present invention;

FIG. 8 illustrates a structure diagram of a color sequential display according to the present invention;

FIG. 9a and FIG. 9b are the coordinate diagrams of the relationship between the liquid crystal response time and the transmittance of the liquid crystal display according to the present invention;

FIG. 10 is a diagram of operating each scan line of the color sequential display according to the first embodiment of the present invention;

FIG. 11 is a coordinate diagram of the liquid crystal response time corresponding to each scan line of the color sequential display shown in FIG. 10 according to the present invention;

FIG. 12 is a diagram of inspecting the time-selecting point when the backlight source turns on corresponding to the color sequential display shown in FIG. 10 according to the present invention;

FIG. 13 is a diagram of operating each scan line of the color sequential display according to the second embodiment of the present invention;

FIG. 14 is a coordinate diagram of the liquid crystal response time corresponding to each scan line of the color sequential display shown in FIG. 13 according to the present invention;

FIG. 15 is a diagram of inspecting the time-selecting point when the backlight source turns on corresponding to the color sequential display shown in FIG. 13 according to the present invention; and

FIG. 16 is a flow chart of controlling and delaying the backlight time of a color sequential display according to the present invention.

### DETAILED DESCRIPTION OF THE PREFERRED EMBODIMENTS

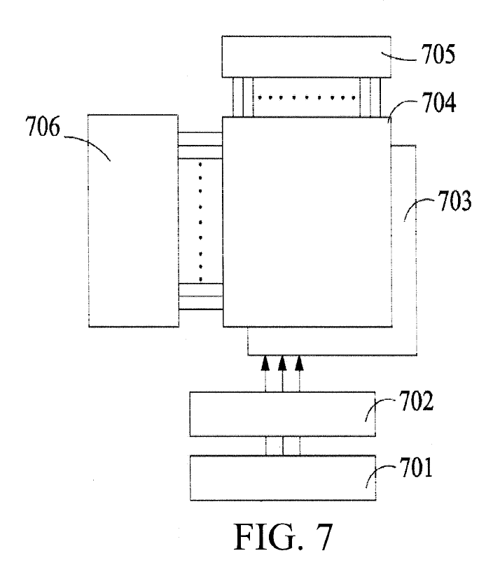

FIG. 7 is a block diagram of a color sequential display having the delay control unit of the backlight time according to the first embodiment of the present invention. The color sequential display includes a liquid crystal panel 704, a backlight source 703, a source data driving circuit 705, a gate scan driving circuit 706, a backlight control circuit 702, and a backlight delay control unit 701. For example, the backlight source 703 is the light emitting diode (LED) Array with three primacy colors. Within three sub-frames of each frame, the backlight source 703 turns on and is sequentially switched to emit the light to the liquid crystal panel 704. The source data driving circuit 705 generates a data line voltage which controls the tilt angle of the liquid crystal molecules. The gate scan driving circuit 706 sequentially provides a scanning line voltage for each scan line on the panel 704. The backlight control circuit 702 provides a backlight driving voltage for driving the backlight source 703 to generate the light sources with three primary colors, respectively, i.e. the red, green, and blue light sources. The backlight delay control unit 701 provides a delay control signal adjusts the time of turn-off status of the backlight source 703 based on a predetermined time interval.

However, the present invention utilizes the backlight source 703 having three primary colors, but not limited. That is, additional light sources can also be used on basis of the design requirement. For example, five kinds of “RRGBB” color light sources or four kinds of “RGBB” color light sources are blended to generate the white light. That is, the LED array having more than three colors is used to obtain the white light. In terms of the display color of the panel, the wider the gamut of the display color, the larger the capacity of the display color of the panel. The light source that the color is the same as the RGB light source can be served as the additional light sources in order to enlarge gamut of the display color. However, the primary wavelength of the additional light source is different from the primary wavelength of the RGB light source. That the color of the additional light source is the same as the color of the RGB light source is applicable to the chromatics field. However, the choice on the additional light sources is not limited in that, and other color sources, such as the cyan or the yellow light sources, besides RGB color also can be used. Even if the color of the additional light source is the same as one of the colors of the RGB light source, which is termed as “metamerism” in the chromatics field, the additional light source can also be utilized. In other words, the additional light source with the same primary wavelength and the same color is different from the RGB light source, which results in different color coordinates. No matter how the light source with the different or same primary wavelength serves as the additional light source, the color coordinates of the additional light source are different from these of the RGB light source. Furthermore, the color coordinates of the additional light source must be located outside the color gamut enclosed by RGB light source so that the color gamut is effectively enlarged.

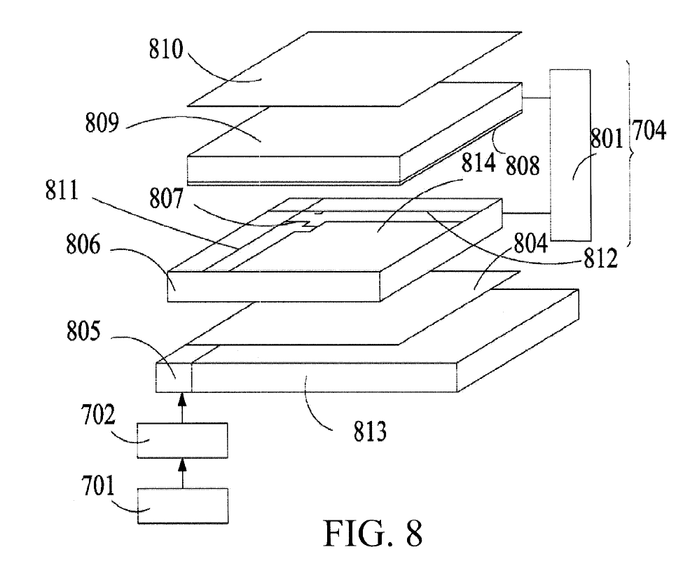

Please refer to FIG. 7 and FIG. 8. FIG. 8 illustrates a structure diagram of a color sequential display according to the present invention. The liquid crystal panel 704 further includes a common electrode 808, located on the first glass substrate 809, and at least one pixel electrode 814, located on the second glass substrate 806 and connected to the thin film transistor 807 correspondingly. In one embodiment, a storage capacitance (not shown) is coupled to the at least one pixel electrode 814 and the common electrode 808. Alternatively, each pixel electrode 814 has its own capacitance in order to retain the potential level of the pixel for coupling with the common electrode 808 and for controlling the twisting of liquid crystal molecules. A light-guiding and light-diffusing plate 813 is positioned between the liquid crystal panel 704 and the backlight source 703 to guide the light generated from the backlight source 703 so that the light diffuses toward the same direction and distributes the light equally. The light is then polarized by the first polarization film 810 and the second polarization film 804.

The driving circuit 801 further includes the source data driving circuit 705 and the gate scan driving circuit 706, respectively, coupled to the pixel electrode 814 and the common electrode 808. The pixel electrode 814 is composed of a plurality of thin film transistors 807 and each thin film transistor 807 serves as a switch. The source data driving circuit 705 is connected to the source of the thin film transistor 807 via the data line 811, and the gate scan driving circuit 706 is connected to the gate of the thin film transistor 807 via the scan line 812 for controlling the on/off statuses of the thin film transistor 807.

When the source data driving circuit 705 and the gate scan driving circuit 706 receives the request to drive the liquid crystal, the source data driving circuit 705 and gate scan driving circuit 706 output a scan line voltage and a data line voltage, respectively, via the scan line 812 and the data line 811. The scan line voltage (or termed as a gate signal) controls the on/off of the thin film transistor 807. The source data driving circuit 705 controls the luminance intensity of the pixel by way of the data line 811 and the thin film transistor 807. The control principle is that the data line voltage is inputted to the liquid crystal capacitance, which is generated from a plate capacitor composed of the first glass substrate 809, the second glass substrate 806 and the liquid crystal therebetween, to control the twisting of liquid crystal molecules. When the thin film transistor 807 is switched to the “off” status, high-impedance is generated to avoid the degradation of the data line voltage. However, the liquid crystal capacitance cannot retain the data line voltage until the next data line voltage is refreshed. Therefore, the liquid crystal capacitance is connected to the storage capacitance in parallel to retain the data line voltage until the next data line voltage is refreshed. After the above-mentioned operation is done, a difference voltage (named the first voltage, described in details later) between the pixel electrode 814 and the common electrode 808 is generated. The adjustment of the difference voltage is employed to control the twisting of the liquid crystal molecules for increasing the transmission intensity of the backlight source 703. Conversely, during the time of the black data insertion (or termed as RESET time), another voltage difference (named the second voltage and described in details later) generated from the voltage difference of common electrode 808 is used to change the twisting of the liquid crystal molecules for reducing the transmission intensity of the backlight source 703.

Because the scan timing of the data line 811 in the liquid crystal panel 704 synchronously controls the starting time of the backlight source 703 and the color of light source based on the generation of the image data, the backlight control circuit 702 receives a synchronous control signal and then sequentially drives the RGB light source for outputting the image within the frame corresponding to an image. The backlight control circuit 702 control the backlight source 703 to switch the RGB light sources (e.g. LED array) 805 for selecting different color light. The color light is emitted to a frame, having three sub-frames, to form the hybrid color image. In addition, the backlight delay control unit 701 further controls the “on/off” statuses of the backlight source 703 so that the “off” status is positioned between two sub-frames. For example, the backlight source 703 is switched off for compensating the luminance intensity while or after the data of the next sub-frame is addressed. In one embodiment, the backlight delay control unit 701 can be delayed by a hardware circuit or software program. The backlight source 703 counts the delay value based on the predetermined display interval, e.g. 5.56 ms, of each sub-frame or based on the predetermined starting time of the backlight source 703, e.g. about 3.9 ms after the first gate is in the “on” status so that the backlight source 703 is switched off to the “off” status at the proper time, e.g. about 5.56 ms after the first gate is in the “on” status. Thus, the “off” status of the backlight source 703 is positioned between two sub-frames.

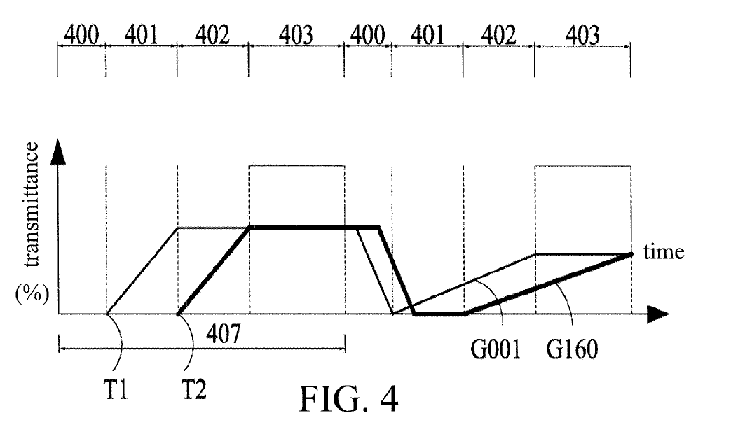

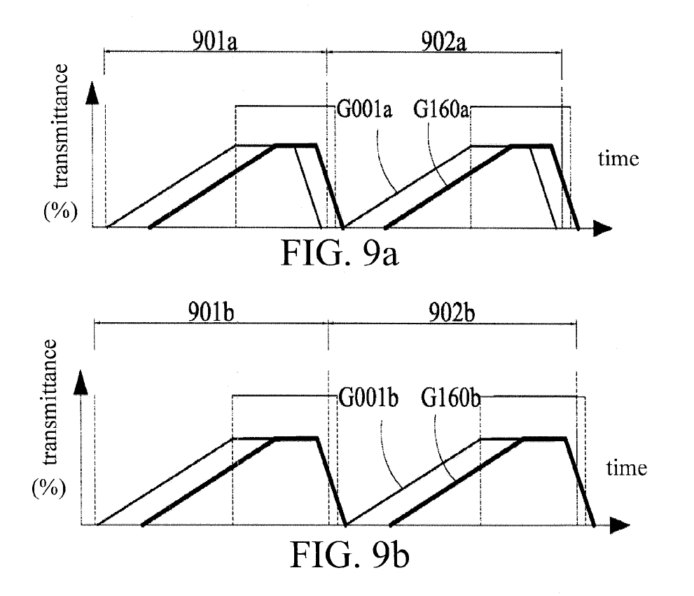

FIG. 9a and FIG. 9b are the coordinate diagrams of the relationship between the liquid crystal response time and the transmittance of the liquid crystal display according to the present invention. FIG. 9a is the coordinate diagram of a LCD display employing the sequential black data insertion technique, and FIG. 9b is a coordinate diagram of a LCD display employing the simultaneous black data insertion technique. In comparison with FIG. 4, the “off” status of the backlight source 703 is delayed from the first sub-frame (901a, 901b) to the next sub-frame (902a, 902b) for compensating the uneven brightness, resulting from the insufficient liquid crystal response time, when the gate scanning zone endures from G001a to G160a or G001b to G160b within data insertion procedure.

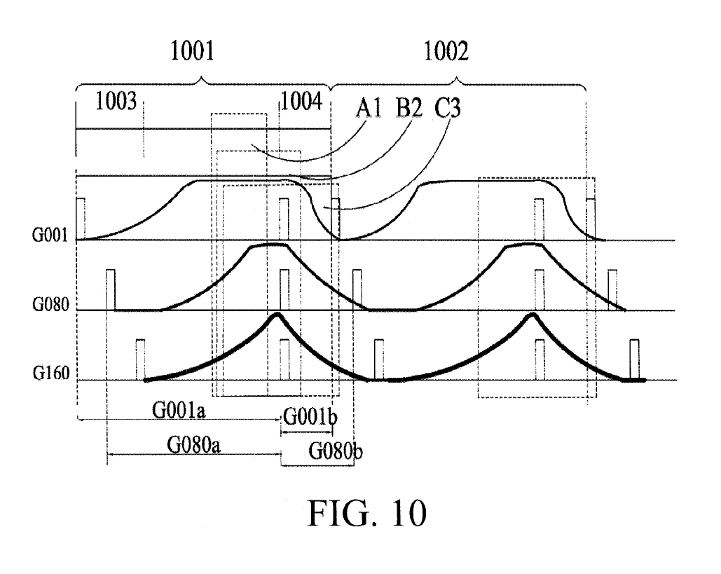

FIG. 10 is a diagram of operating each scan line of the color sequential display according to the first embodiment of the present invention. Each gate is driven in each sub-frame. For example, the display interval of the first sub-frame 1001 is divided into a first time interval and a second time interval. In the first time interval, the gate scan driving circuit 706 transmits a gate signal to the thin film transistor for driving the thin film transistor to be “on” status and generating a difference voltage between the pixel electrode 814 and the common electrode 808. The difference voltage, named as the first voltage, is used to control the twisting of the liquid crystal molecules to obtain the required light quantity therethrough. For example, the first scan line has first time interval, G001a, and the 80th scans line has 80th time interval, G080a. On the contrary, during the second time interval, a difference voltage between the pixel electrode 814 and the common electrode 808 is the reset voltage, i.e. the second voltage, to control the twisting of liquid crystal molecules to be in opaque status. In one case, the storage capacitance between the pixel electrode 814 and the common electrode 808 is changed to adjust the difference voltage for generating the second voltage. In another case, the common electrode 808 is divided into a plurality of regions and the regions are adjusted to generate the second voltage. In one case, the polarity of first voltage is opposite to the polarity of the second voltage. In another case, the polarity of first voltage is the same as the polarity of the second voltage. For example, the polarity of a frame is opposite to the polarity of the next frame. The polarity past three sub-frames is conversely changed. Thus, during the six continuous sub-frames, a plurality of polarity arrangement can be used. As shown in FIG. 10, G001a is the first time interval of the first scan line, G001b is the second time interval of the first scan line, G080a is the first time interval of the 80th scan line, and G080b is the second time interval of the 80th scan line. Taking an example of the scan driving circuit with 160 scan lines, a scan driving circuit sequentially drives the pixel electrode and the common electrode from the first scan line to the 160th scan line for generating the first voltage and changing the state of the liquid crystal. Thus, the light of the backlight source pass through the liquid crystal. In the first time intervals of the gate scans, a scan time difference is positioned between the first scan line, G001, and the 160th scan line, G160, of the gate, which results in the uneven transmittance between the top pixel region and the bottom pixel region of the panel, i.e. transmittance of G001 is greater than transmittance of G160. The backlight delay control unit outputs a delay signal to the backlight control circuit so that the backlight is turned off with delay. FIG. 10 further shows three embodiments of turning the backlight source off. First, the brightness of the panel is compensated when the backlight source is turned off at the first time-selecting point, A1, i.e. the interval between starting point and end point of the first time interval in each gate scan of the first sub-frame. After the first time interval is over and when the black data insertion procedure is operated at the second time interval, the scan driving circuit simultaneously drives the pixel electrode and the common electrode from the first scan line to the 160th scan line for generating the second voltage and changing the state of the liquid crystal. Thus, a black image is outputted. A scan time difference is positioned between the second time interval, G001b, of the first scan line, G001, and the second time interval, G080b, of the 80th scan line of the gate. Secondly, the brightness difference of the panel is compensated when the backlight source is turned off at the second time-selecting point, B2, i.e. the interval between starting point and end point of the second time interval in each gate scan of the first sub-frame. The brightness difference is caused by the insufficient response time of the liquid crystal. When operating the black data insertion procedure on the next sub-frame 1002, the time difference between the one scan line and the next scan line is the cause of the uneven brightness. Third, the brightness of the panel is compensated when the backlight source is turned off at the third time-selecting point, C3, i.e. the interval between starting point and end point of the first time interval in each gate scan of the second sub-frame. Many methods can be used to ensure that the backlight light source is turned off at the third time-selecting point, C3, between the first sub-frame and the second sub-frame. For example, the sum of a predetermined time and the starting time point of the first time interval in each sub-frame serves as the turn-off time of the backlight source. The predetermined time is preferably greater than the display time, e.g. 5.56 ms, in each sub-frame. Further, the predetermined time can be stored in the memory in advance so that the backlight delay control unit is capable of reading the predetermined time.

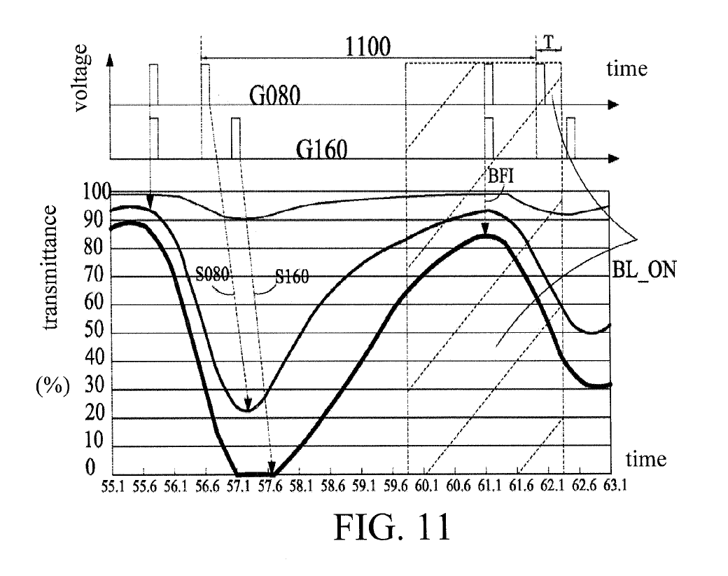

FIG. 11 is a coordinate diagram of the liquid crystal response time corresponding to each scan line of the color sequential display shown in FIG. 10 according to the present invention. The horizontal coordinate represents the timing axis (unit: ms) and the vertical coordinate represents the transmittance percentage. BL_ON represents the “on” status of the backlight source. S080 represents the scan timing of the 80th scan line of the gate and S160 represents the scan timing of the 160th scan line of the gate. The three profiles shown in FIG. 11 represent the relationship between the liquid crystal response time and the transmittance corresponding to three different scan lines, respectively, in FIG. 10. The first profile is corresponding to the first scan line G001, the second profile is corresponding to the 80th scan line G080, and the third profile is corresponding to the 160th scan line G160. In FIG. 11, the first scan line G001 is different from the 160th scan line G160 because of the difference between the scan time and the liquid crystal response time, and the scan timing order from each scan line of the black data insertion in a sub-frame to each scan line in the next sub-frame is different after the simultaneous black data insertion (BDI) is operated. However, since the transmittance of the bottom pixel region, e.g. the 160th scan line G160, of the panel is adjusted by a backlight delay time “T”, the liquid crystal has enough response time to increase the transmittance of the panel so that the panel has uniform brightness. The backlight delay time “T” is generated when the backlight delay control unit delays the turn-off time of the backlight source to a predetermined time.

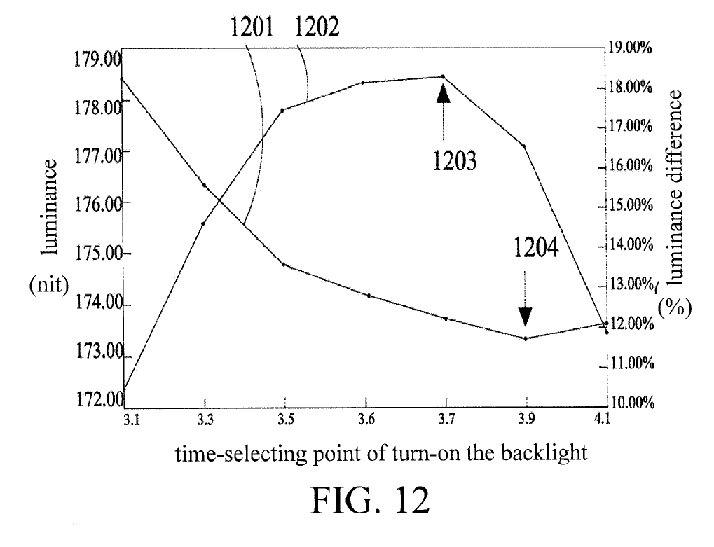

FIG. 12 is a diagram of inspecting the time-selecting point when the backlight source of the color sequential display turns on in the present invention shown in FIG. 10 according to the present invention. The horizontal coordinate represents the starting time of the backlight source of the liquid crystal display. The left vertical coordinate represents the luminance (unit: nit) which is the brightness value per unit area at a predetermined direction. The right vertical coordinate represents the luminance difference (unit: %) and the less of whose value, the better of the result. For example, if the display interval of each sub-frame in a color sequential display is 5.56 ms, the display interval is then subtracted by the turn-on time of the backlight source and equal to 2.0 ms. The liquid crystal should completely responds before the backlight source is turned on. When a luminance profile 1202 is positioned at the time 3.7 ms, which is defined as the time when the backlight source turns on after the scan line G001 is scanned past 3.7 ms, the backlight source reaches an even luminance point 1203 for the panel. When the liquid crystal completely responds at the time 3.9 ms, a luminance difference profile 1201 has an improved luminance deviation point 1204 and thus the panel has luminance uniformity.

According to the above-mentioned descriptions, the liquid crystal display in the present invention delays the turn-off time of the backlight source to increase the transmittance and the luminance uniformity of the panel. Further, the Gamma curves are also improved due to the improvement of the luminance uniformity of the panel.

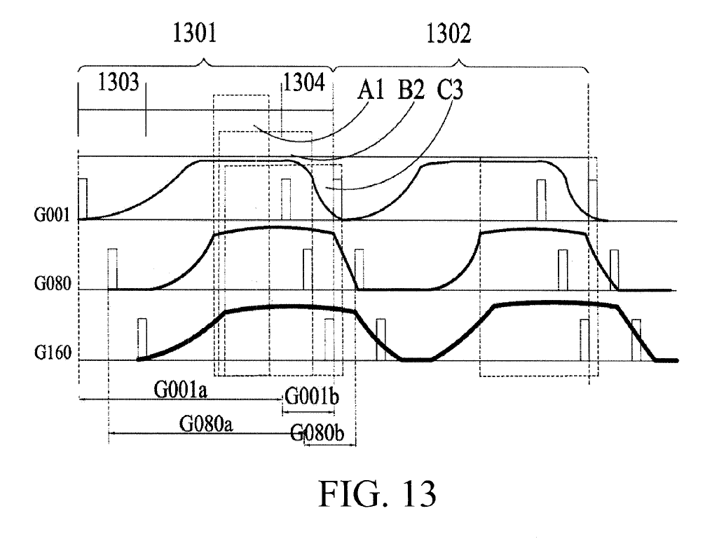

FIG. 13 is a diagram of operating each scan line of the color sequential display according to the second embodiment of the present invention. In comparison with the first embodiment, the sequential black data insertion is employed for each scan line of the color sequential display in the second embodiment. Similarly, the backlight delay control unit controls the turn-off time of the backlight source at the first time-selecting point, A1, i.e. the interval between starting point and end point of the first time interval in each gate scan of the first sub-frame, or at the second time-selecting point, B2. In another case, the backlight delay control unit controls the turn-off time of the backlight source at the third time-selecting point, C3, i.e. the interval between starting point and end point of the first time interval in each gate scan of the second sub-frame. Therefore, the uneven luminance because of insufficient liquid crystal response time is compensated.

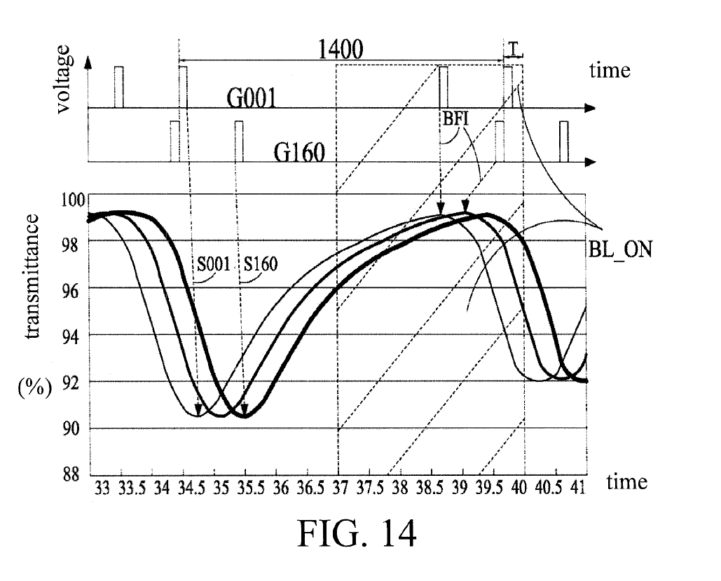

FIG. 14 is a coordinate diagram of the liquid crystal response time corresponding to each scan line of the color sequential display shown in FIG. 13 according to the present invention. S160 represents the scan timing of the 160th scan line of the gate. Since the sequential black data insertion (BDI) is employed in the second embodiment, the response time of the liquid crystal is smaller than that in the first embodiment. However, because the black data insertion (BDI) time of each the scan line is the same, the transmittance difference between the top pixel region and the bottom pixel region in the second embodiment is smaller than that in the first embodiment. Similarly, the backlight delay time “T” delays the turn-off time of the backlight source to compensate the transmittance decrement of the panel so that the panel has uniform luminance.

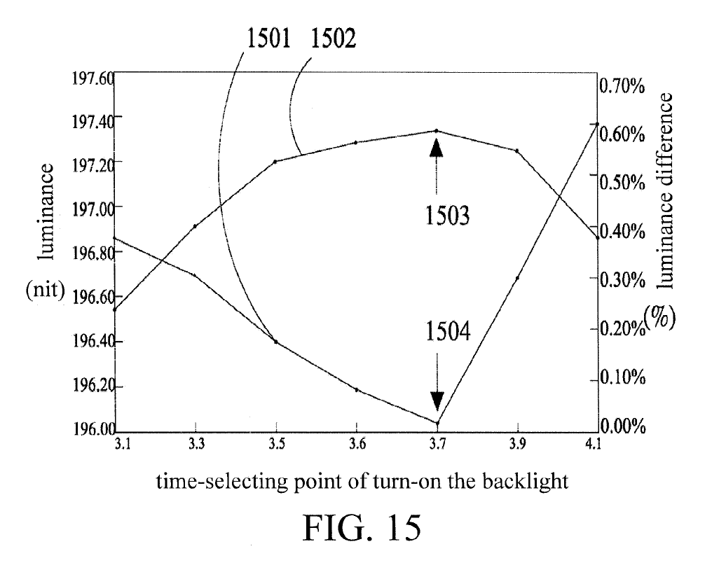

FIG. 15 is a diagram of inspecting the time-selecting point when the backlight source of the color sequential display turns on in the present invention shown in FIG. 13 according to the present invention. The horizontal coordinate represents the starting time of the backlight source of the liquid crystal display and the starting time of the backlight source is defined as the time when the backlight source turns on after the scan line G001 is scanned past a predetermined time. The left vertical coordinate represents the luminance (unit: nit) which is the brightness value per unit area at a difference (unit: %) and the less of whose value, the better of the result. In comparison with the first embodiment in FIG. 12, the luminance uniformity in the second embodiment is better than that in the first embodiment referring to the luminance difference profile 1501 and the luminance deviation point 1504.

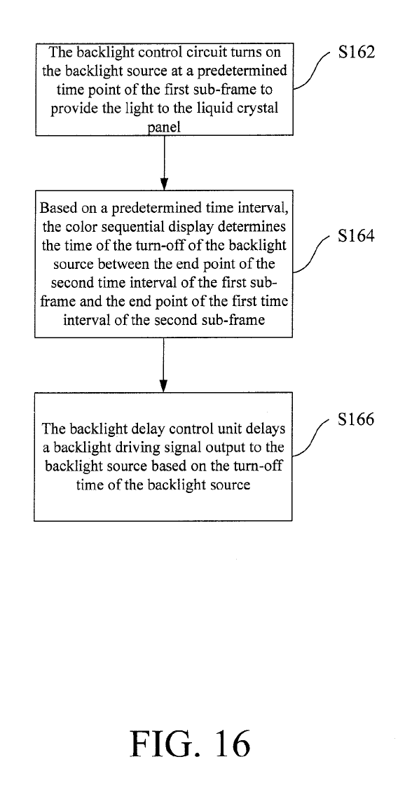

Please refer to FIG. 7, FIG. 8 and FIG. 16. FIG. 16 is a flow chart of controlling and delaying the backlight time of a color sequential display according to the present invention. As shown in FIGS. 7 and 8, the color sequential display includes a liquid crystal panel 704, a backlight source 703, a backlight control circuit 702, and a backlight delay control unit 701. The liquid crystal panel 704 generates each image frame having a plurality of sub-frames including a first sub-frame and a second sub-frame. Each sub-frame has a first time interval and a second time interval. The backlight source 703 generates the light. The backlight control circuit 702 controls the turn-on or turn-off time of the backlight source 703. The backlight delay control unit 701 delays the turn-off time of the backlight source 703. The method of controlling and delaying the backlight time of a color sequential display includes the following steps:

S162: The backlight control circuit 702 turns on the backlight source 703 at a predetermined time point (e.g. the time point in the first time interval) of the first sub-frame to provide the light to the liquid crystal panel.

S164: Based on a predetermined time interval, the color sequential display determines the time of the turn-off of the backlight source 703 between the end point of the second time interval of the first sub-frame and the end point of the first time interval of the second sub-frame. Many methods can be used to ensure that the backlight light source is turned off at the time point within the second sub-frame. For example, the sum of the predetermined time and the starting time point of the first time interval in each sub-frame serves as the turn-off time of the backlight source. The predetermined time is preferably greater than the display time, e.g. 5.56 ms, in each sub-frame. Alternatively, the sum of the predetermined time and the end time of the second time interval in each sub-frame serves as the turn-off time of the backlight source. The predetermined time is preferably smaller than the first time interval in each sub-frame. In another case, the predetermined time is a default turn-on time of the backlight source 703. When calculating the time from the starting time point of the backlight source to the predetermined time, the color sequential display can ensure that the backlight light source is turned off at the time point within the second sub-frame. Further, the predetermined time can be stored in the memory in advance so that the backlight delay control unit 701 is capable of reading the predetermined time.

S166: The backlight delay control unit 701 delays a backlight driving signal output to the backlight source based on the turn-off time of the backlight source so that the turn-off time of the backlight source is delayed to the time between the end point of the second time interval of the first sub-frame and the end point of the first time interval of the second sub-frame.

As is understood by a person skilled in the art, the foregoing preferred embodiments of the present invention are illustrative rather than limiting of the present invention. It is intended that they cover various modifications and similar arrangements included within the spirit and scope of the appended claims, the scope of which should be accorded the broadest interpretation so as to encompass all such modifications and similar structures.

What is claimed is:

1. A color sequential display, comprising:
a liquid crystal panel having a plurality of pixels, for generating a plurality of frames, wherein each frame is divided into a plurality of sub-frames having at least one first sub-frame and at least one second sub-frame;
a backlight source having a plurality of light sources, for generating light and providing the light to the liquid crystal panel;
a driving circuit electrically connected to at least one scan line and at least one data line, for generating a first voltage and a second voltage to switch the turn-on/off statuses of the pixels and dividing each sub-frame into a first time interval and a second time interval, wherein the first voltage switches the turn-on/off statuses of the pixels at the first time interval and the second voltage switches the turn-on/off statuses of the pixels at the second time interval;
a backlight control circuit for controlling the time of the turn-on status of the backlight source; and
a backlight delay control unit for controlling the turn-off status of the backlight source and adjusting the time of the turn-off status between an end point of the second time interval of the at least one first sub-frame and an end point of the first time interval of the at least one second sub-frame.

2. The color sequential display of claim 1, wherein the backlight control circuit controls the plurality of light sources of the backlight source to correspondingly switch the light sources, which have a plurality of different colors, to the sub-frames.

3. The color sequential display of claim 1, wherein the liquid crystal panel further comprises a pixel electrode and a common electrode for controlling the pixels.

4. The color sequential display of claim 3, wherein the driving circuit further comprises a storage capacitance electrically coupled to the pixel electrode and the common electrode.

5. The color sequential display of claim 4, wherein a difference voltage of the common electrode is adjusted to generate the second voltage.

6. The color sequential display of claim 4, wherein the common electrode is divided into a plurality of regions to adjust the difference voltage of at least one of the regions for generating the second voltage.

7. The color sequential display of claim 1, wherein the driving circuit comprises a scan driving circuit for outputting a gate signal to a gate of a thin film transistor via the at least one scan line.

8. The color sequential display of claim 7, wherein the scan driving circuit sequentially generates the second voltage based on the gate signal to drive the pixels.

9. The color sequential display of claim 7, wherein the scan driving circuit simultaneously generates the second voltage based on the gate signal to drive the pixels.

10. The color sequential display of claim 7, wherein the driving circuit further comprises a data driving circuit electrically coupled to a source of the thin film transistor via the at least one data line.

11. The color sequential display of claim 1, wherein the backlight delay control unit is a hardware circuit or a software program.

12. The color sequential display of claim 1, wherein the backlight delay control unit controls to delay the time of the turn-off status of the backlight source based on a display interval of each sub-frame.

13. The color sequential display of claim 1, wherein the backlight delay control unit controls to delay the time of the turn-off status of the backlight source based on the time of the turn-on status of the backlight source.

14. The color sequential display of claim 1, wherein the polarity of the first voltage is opposite to the polarity of the second voltage.

15. The color sequential display of claim 1, wherein the polarity of the first voltage is the same as the polarity of the second voltage.

16. A method of controlling a color sequential display, using for delaying the backlight time of a backlight source of the color sequential display, wherein at least one frame of the color sequential display comprises at least one first sub-frame and at least one second sub-frame, and each sub-frame is divided into a first time interval and a second time interval, the method comprising the steps of:
turning-on the backlight source at the time of the turn-on status of the at least one first sub-frame;
determining the time of the turn-off status of the backlight source between an end point of the second time interval of the at least one first sub-frame and an end point of the first time interval of the at least one second sub-frame based on a predetermined time interval; and
delaying a backlight driving signal output to the backlight source based on the time of the turn-off status of the backlight source.

17. The method of claim 16, further comprising a step of adding the predetermined time interval to the starting time point of the first time interval in each sub-frame to determine the time of the turn-off status of the backlight source, wherein the predetermined time interval is greater than the display interval in each sub-frame.

18. The method of claim 16, further comprising a step of adding the predetermined time interval to the end time of the second time interval in each sub-frame to determine the time of the turn-off status of the backlight source, wherein the predetermined time interval is smaller than the first time interval in each sub-frame.

19. The method of claim 16, wherein the predetermined time interval is a default time interval of the turn-on status of the backlight source.

20. The method of claim 16, wherein a backlight delay control unit controls a backlight control circuit for delaying the backlight driving signal output to the backlight source based on the predetermined time interval.

21. The method of claim 16, wherein the backlight delay control unit is a hardware circuit or a software program.
